(19) United States
(12) Patent Application Publication
(10) Pub. No.: US 2010/0074187 A1
(43) Pub. Date: Mar. 25, 2010

(54) DYNAMIC QUALITY OF SERVICE CONTROL TO FACILITATE FEMTO BASE STATION COMMUNICATIONS

(76) Inventors: Dong Sun, Morristown, NJ (US); Peter Busschbach, Basking Ridge, NJ (US); Frank Favichia, Sparta, NJ (US); Ramesh Nagarajan, Princeton Junction, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/237,838

(22) Filed: Sep. 25, 2008

(51) Int. Cl. H04W 28/16

(52) U.S. Cl. 370/329

(57) ABSTRACT

An exemplary method of facilitating communications involving a Femto base station (F-BS) includes establishing an association between the F-BS and a wireline backhaul resource used by the F-BS for initiating at least one traffic flow of the F-BS for a wireless communication session. Quality of service information for the wireless communication session is determined. The determined quality of service information allows for determining a corresponding quality of service requirement of the backhaul resource in the packet transport network. The established association is used for identifying the corresponding quality of service to the F-BS on the wireline backhaul resource of the established association during the wireless communication session.

### FIELD OF THE INVENTION

This invention generally relates to communication. More particularly, this invention relates to communications involving privately employed base stations such as Femto base stations.

### DESCRIPTION OF THE RELATED ART

Wireless communication systems are well known and in widespread use. Typical cellular communication arrangements include a plurality of base station transceivers (BTS) strategically positioned to provide wireless communication coverage over selected geographic areas. A mobile station (e.g., notebook computer or cellular phone) communicates with a base station transceiver over an air interface utilizing specific wireless access technology protocols. The base station transceiver communicates with a wireless network over a backhaul connection to facilitate communications between the mobile station and another device. With most such arrangements, each base station has a dedicated backhaul connection that ensures adequate signaling traffic capacity or bandwidth to allow for providing a desired quality of service to the mobile stations communicating through that base station.

With advances in wireless communication technology, it has become increasingly desirable to provide wireless coverage within buildings or other areas where existing base stations are not providing reliable wireless coverage.

Current RAN Architectures (BTS-BSC) have fundamental limitations for supporting high data rates. Range and coverage are also issues which cause unreliable, low data rate delivery at cell edges. Signal strength (in dB scale) decays log-linearly with the distance between the BTS and the mobile station. The signal to noise ratio at the cell edge is interference limited with aggressive frequency reuse targets (reuse 1 & 3). Additionally, higher frequency bands (2.3, 2.5, 3.5 GHz) are more vulnerable to non-Line-Of-Sight radio propagation losses.

Monolithic RAN architecture hierarchies include RAN backhauls (e.g., T1/E1) which are bandwidth (BW) limited, expensive (e.g., they have a monthly re-occurring cost) and designed for circuit switched voice systems. Broadband interfaces (e.g., G-Ethernet/SDH/Fiber) are expensive, not available due to regulatory and geographic restrictions or both.

One proposal in this regard has been to provide Femto base station (F-BS) transceivers that can be installed by consumers within buildings, for example. A F-BS establishes a much smaller area of wireless coverage compared to a typical macrocell base station transceiver.

Deploying F-BSs presents special challenges to network operators. One aspect associated with the deployment of F-BSs is how to provide adequate quality of service to the subscribers accessing a wireless communication network through a F-BS. Current mechanisms cannot guaranty the quality of service that is desired for many wireless communications involving F-BSs.

For example, it is not economic or feasible to preallocate bandwidth on a backhaul resource and dedicate that portion of the backhaul resource to a F-BS. In typical scenarios, a F-BS will utilize a backhaul connection such as a DSL line that is also used within a residence for other services. In current DSL deployments, the UpLink (UL) BW resources are limited and sensitive to network operations. Permanently allocating a portion of the DSL bandwidth to the F-BS will undesirably prevent those resources from being utilized for other services. Moreover, a F-BS typically will not be active at all times and, therefore, a pre-allocation of such resources will be wasted much, if not most, of the time.

Dynamic quality of service approaches currently in use in wireless communication networks do not address the issue of backhaul transport capacity to ensure quality of service for F-BSs. Wireless network signaling protocols are not recognized by wireline packet transport networks such that backhaul resources and associated control devices are not capable of performing quality of service control in the same way that the wireless quality of service is managed. Different standard functional systems and mechanisms exist for quality of service control in wireless networks and fixed transport networks, respectively.

### SUMMARY

An exemplary method of facilitating communications involving a Femto base station (F-BS) includes establishing an association between the F-BS and a wireline backhaul resource used by the F-BS for initiating traffic flows of the F-BS for a wireless communication session. Quality of service information for the wireless communication session is determined. The quality of service information allows for determining a corresponding quality of service requirement for the wireline backhaul. The established association is used for providing the corresponding wireline quality of service to the F-BS on the wireline backhaul resource of the established association during the wireless communication session.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a communication network designed according to an embodiment of this invention.

FIG. 2 is a signaling flow diagram summarizing an example approach.

FIG. 3 illustrates an example procedure to establish and discover the association between a femto request and backhaul resource.

### DETAILED DESCRIPTION

The following examples facilitate communications involving Femto base stations (F-BSs). An association is made between a F-BS and wireline backhaul resources utilized by that F-BS. Quality of service parameters for a wireless communication session involving the F-BS and the established association allow for determining a corresponding quality of service requirement for the wireline backhaul resource and providing that quality of service to the F-BS during the wireless communication. This dynamic approach to ensuring quality of service from an end-to-end perspective for a wireless communication involving a F-BS ensures quality of service over the backhaul resource in a reliable and efficient manner.

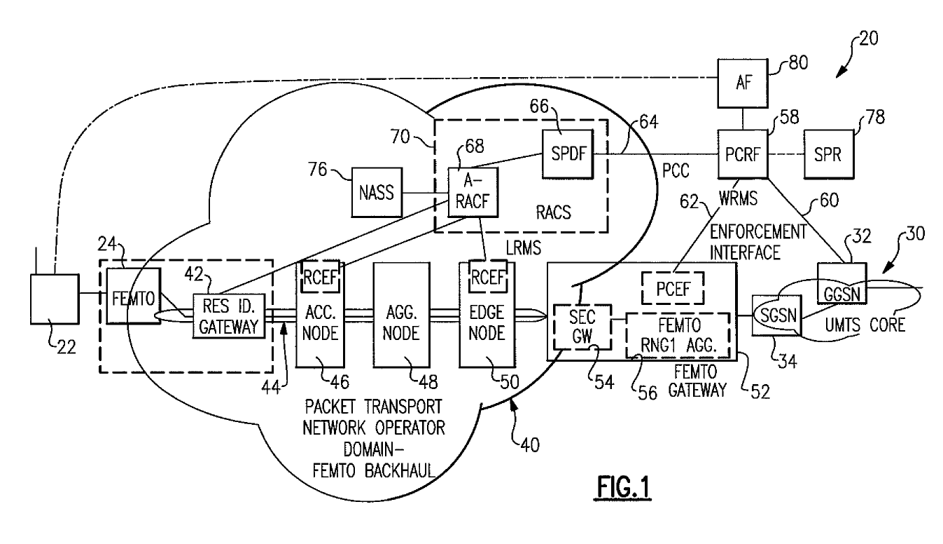

FIG. 1 schematically illustrates a communication arrangement 20 for facilitating wireless communications between a mobile station 22 and a F-BS 24. In this description, the term “F-BS” refers to a communication device including a transceiver that provides wireless communication coverage over a relatively small area. A F-BS includes features making it an access point through which a larger communication network becomes accessible to a mobile station.

A F-BS is distinct from a macrocell base station and from a picocell base station. The distinction is based primarily on the limited range of wireless coverage provided by the F-BS. Another distinction is associated with how F-BSs are deployed. Typical F-BSs utilized in example embodiments of this invention will be installed by consumers without requiring a network operator to provide dedicated backhaul resources to the F-BS. The F-BS will utilize an existing connection such as a DSL connection for purposes of making a backhaul connection to the network that facilitates wireless communications on behalf of the mobile station 22.

In the example of FIG. 1, selected portions of a core network 30 operate in a generally known manner to facilitate wireless communications. The illustrated example includes a gateway general support node (GGSN) 32 and a serving GPRS support node (SGSN) 34. In one example, the core network 30 operates according to known UMTS standards. In another example, CDMA communication standards are utilized within the core network 30.

A wireline packet transport network portion 40 facilitates the backhaul communications between the F-BS 24 and the core network 30. In this example, a residential gateway 42 facilitates making a connection between the F-BS 24 and a backhaul resource connection 44 such as a DSL line, for example. Various backhaul resource connections can be utilized. DSL is shown as only one example type of backhaul resource connection. The example backhaul resource includes an access node 46, an aggregation node 48 and an edge node 50.

The example of FIG. 1 includes a Femto gateway 52 that includes a security gateway subsystem 54 and an aggregator subsystem 56. The security gateway subsystem 54 and the aggregator subsystem 56 facilitate a plurality of F-BSs accessing the SGSN 34 of the core network 30 for purposes of establishing wireless communication sessions on behalf of a mobile station such as the mobile station 22.

For example, a new service request or a handover is signaled by the F-BS 24 over the backhaul resource 44 to the SGSN 34, which is an anchor point of the core network 30. The SGSN 34 communicates with the GGSN 32 by sending a transport session creation message (i.e., create PDP context). The GGSN 32 communicates with a policy and charging rules function (PCRF) 58 over an interface 60 to create the transport session and obtain quality of service authorization. In this example, the SGSN 34 sends a request to the Femto gateway 52 for radio access network (RAN) bearer and radio bearer creation. The Femto gateway 52 in this example derives information for backhaul resource control and provides that to the PCRF 58 over an interface 62. In one example, the information for backhaul resource control includes an identification of the F-BS 24, quality of service information from the SGSN 34 and a required bandwidth.

The PCRF 58 performs a policy check based on a service level agreement (SLA) and forwards the request over a policy interface 64 to a peer service-based policy decision function (SPDF) 66. In this example, the SPDF 66 interacts with a resource access control facility (A-RACF) 68 for policy and resource admission if sufficient resources are available. In one example, the A-RACF 68 instructs the resource reservation or allocation in the appropriate enforcement point of the backhaul. This is schematically shown in FIG. 1 by the links between the A-RACF 68 and the residential gateway 42, the RCEF portion of the access node 46 and the RCEF portion of the edge node 50. Any one or a combination of these can act as the enforcement point. In this example, the SPDF 66 and the A-RACF 68 are part of a resource and admission control system (RACS) 70 of the wireline packet transport network 40.

The A-RACF 68 also communicates with a network attachment sub-system (NASS) 76. The NASS 76 is responsible for the subscription management functions such as dynamic provision of IP address and other user equipment configuration parameters (e.g. using DHCP), user authentication, authorization of network access, access network configuration, and location management. The NASS 76 interacts with the wireline resource management system to retrieve the backhaul resource information associated to the femto request in this case.

In the illustrated example, the PCRF 58 also communicates with a SPR 78. The SPR contains all subscriber/subscription related information needed for subscription-based policies and IP-CAN bearer level PCC rules by the PCRF. The PCRF will query the SPR for the subscription checking of the femto request before forwarding to the wireline resource management system

The example of FIG. 1 also includes a Application Function (AF) 80 for controlling the application session initiated from the end user such as a VoIP call from a mobile station accessing the F-BS 24.

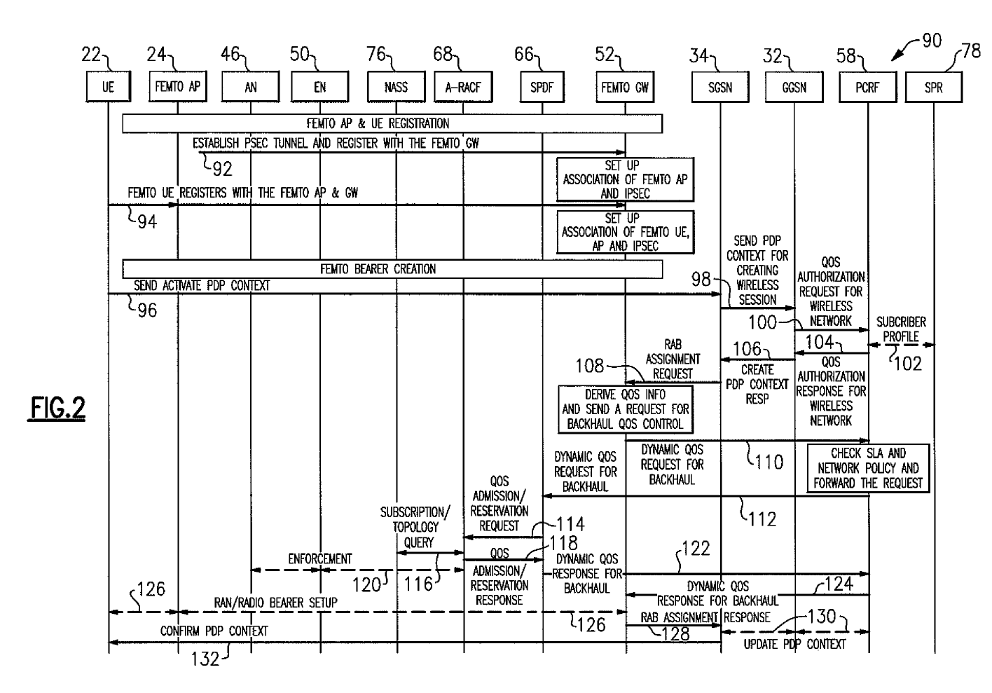

FIG. 2 includes a signaling flow diagram 90 summarizing an example approach for establishing end-to-end dynamic quality of service control for a wireless communication session involving the example F-BS 24 and the example wireless station 22. As shown at 92, the F-BS 24 signals the Femto gateway 52 for establishing a secure communication tunnel over the backhaul resource 44 and registering the F-BS 24 with the Femto gateway 52. At 94, the mobile station 22 registers with the F-BS 24 and that information is forwarded to the Femto gateway 52.

One aspect of this example is that the Femto gateway 52 establishes an association between the F-BS 24 and the backhaul resources utilized by the F-BS 24 for purposes of registering with the Femto gateway 52. In other words, the Femto gateway 52 associates an identifier of the F-BS 24 with the particular wireline packet transport network elements and circuits utilized for communicating with the F-BS 24. In one example, the Femto gateway determines a unique identifier of the F-BS 24. One example includes using an IP address of the F-BS 24. The IP address may be the globally routable IP address and associated address realm of the authorized F-BS assigned by the wireline packet transport network operator. In one example, the RACS 70, which is a portion of the wireline resource management system, resolves the unique ID of the F-BS 24 into the IP addresses of pertinent wireline packet transport elements and the circuit IDs (e.g., ATM VC or VLAN, VPN) from the NASS 76 for uniquely allocating the transport resources for resource admission and policy enforcement.

In one example, upon receiving the registration of the mobile station 22, the Femto gateway 52 also associates the identity of the mobile station 22 with the established association of the F-BS 24 and the corresponding backhaul resources. In one such example, an association table is established that includes (i) the identity such as the IMSI or P-TMSI associated with the SIM or USIM in the mobile station, (ii) the global identity of the F-BS associated with the core network 30 including the RAC and LAC of the F-BS, and (iii) a Femto backhaul resource identifier such as the global identity of the F-BS associated with the wireline packet transport network operator (i.e. the Femto broadband ID) that consists of a globally routable IP address field and address realm field.

In one example, the association table is established in the Femto gateway 52 by first creating the association between the F-BS 24 and the corresponding backhaul source such as an IPSec tunnel between the Femto gateway 52 and the F-BS 24.

In one example, the Femto gateway 52 latches the source IP address of the exterior IP packet header as the globally routable IP address field in the Femto broadband ID when it receives the register request from the F-BS 24. In one example, the Femto gateway 52 derives the realm information of the packet network (i.e., the backhaul transport network) based on the IPSec tunnel ID and the F-BS ID. In one example, the Femto gateway 52 contacts a configuration server to look up this information if it is not available locally to the Femto gateway 52.

The mobile station ID provided by the F-BS 24 to the Femto gateway 52 regarding the mobile station 22 is extracted by the Femto gateway 52 and associated with the F-BS ID.

In FIG. 2, at 96, a signal originating from the mobile station 22 indicates a desire to create a wireless communication session. One example comprises an activate PDP context message. The SGSN 34 checks the request and initiates a PDP context creation procedure by communicating with the GGSN 32 as schematically shown at 98. The GGSN 32 initiates a quality of service authorization session by communicating with the PCRF 58 as schematically shown at 100. This portion of the process pertains to the core network 30 resources used for the wireless communication session.

As shown at 102, the PCRF 58 queries the SPR 78 for wireless subscription profile information if it is not available locally to the PCRF 58. At 104, the PCRF 58 communicates the quality of service authorization response for the wireless communication session over the wireless network resources to the GGSN 32. At 106, the GGSN 32 provides a create PDP context response to the SGSN 34.

At 108 the SGSN 34 sends a radio access bearer (RAB) assignment request message to re-establish radio access bearers for PDP context to the Femto gateway 52. In one example, the RAB assignment request includes RAB ID information, TEID(s), quality of service profile information and SGSN IP address information. The Femto gateway 52 responds by deriving the identifier information of the mobile station 22 according to the information conveyed in the RAB assignment request from the SGSN 34. The Femto gateway 52 then uses the established association to find the appropriate Femto broadband ID (i.e., the globally routable IP address with the realm information) and initiates a resource admission and reservation session with the wireless resource management system. As schematically shown at 110, the Femto gateway 52 communicates with the PCRF 58 over the enforcement interface 62 to provide the Femto broadband ID, requested bandwidth, quality of service class, traffic characteristics and reservation duration information. In one example, the P-TMSI or IMSI of the mobile station 22 is derived from the RAB ID and used as the key to derive the pertinent Femto broadband ID from the established association.

In one example, the information exchanged between the Femto gateway 52 and the PCRF 58 over the enforcement interface 62 includes information elements generated in the Femto gateway 52. Such information elements include a request session ID, the Femto gateway ID, the F-BS ID, the wireless connection ID (e.g., PDP context) and a traffic description. The information regarding the traffic description may include upstream information, downstream information or both. Other information includes a quality of service class designation applicable to the wireless core network 30, an IP flow classifier of the backhaul resource such as the source address, destination address and port number of the IPSec. The traffic description information may also include bandwidth information and traffic characteristics such as data rate and packet size.

The PCRF 58 checks a service level agreement, network policy or both to authorize the request. In this example, the PCRF 58 is configured to map the quality of service associated with the wireless communication session to generic quality of service parameters that can be used by the wireline packet transport network 40. The PCRF 58 in this example forwards the request and the generic quality of service parameters to the SPDF 66 as schematically shown at 112. Information elements that are communicated over the policy interface 64 in one example include information generated at the Femto gateway. Such information includes a request session ID, a requestor name (i.e., an identifier of the PCRF 58), the F-BS ID and traffic description information.

Interaction between the wireless resource management system (e.g., the PCRF 58) and the wireline resource management system 70 includes realm based peer discovery and routing. In one example, the wireless operator maintains the peer wireline resource management system IP address in a table. The realm information is extracted from the realm field of the Femto broadband ID in the quality of service request message sent from the Femto gateway 52. The realm in the resource request from the Femto gateway 52, which in some examples comes from a PCEF portion of a Femto gateway, is used as a primary key in the table look up procedures. The table look ups can be based on a longest-match-from-the-right on the realm to avoid requiring an exact match. Using such a longest-match approach allows for speeding up a look up time, for example.

The PCRF 58 of the wireless resource management system in one example checks the white list against the realm provided in the resource request message to ensure an appropriate security and trust relationship before performing the look up. Additionally, in one example the wireless resource management system also determines whether it should send the request to the wireline resource management system 70 for resource admission of the backhaul. The wireless resource management system makes this decision based on the service level agreement with the wireline packet transport network operator and the resource reservation method used in the wireless network.

In one example, at the wireless resource management system side, upon receipt of the resource request from the Femto gateway 52, the PCRF 58 resolves the IP address of the peer wireline resource management system from an appropriate routing table. The PCRF 58 then checks the white list for authorized requesters. Next, the PCRF 58 in one example checks the service level agreement and reservation method to determine the next operator. If a per flow reservation mode is used, the wireless resource management system sends the resource admission request to the wireline resource management system including the F-BS ID, the requested bandwidth, traffic characteristics and quality of service class information. In one example, an IP flow classifier and mediate type are also provided for enforcement purposes. If an aggregation reservation method is used, the wireless resource management system in one example performs the resource availability check to determine if residual resources are sufficient for the new request. If not, it sends the request to increase the watermark of resource reservation.

On the wireline resource management side, upon receipt of the resource request over the policy interface 64, a white list is checked for authorized requesters and the service level agreement is consulted. This allows for checking the total bandwidth authorized to the wireless operator, for example. The subscriber profile and resource information are then checked including the address of anchor network elements, circuit ID and topology. Such information is available to be retrieved from the NASS 76 using the F-BS ID from the established association as the key.

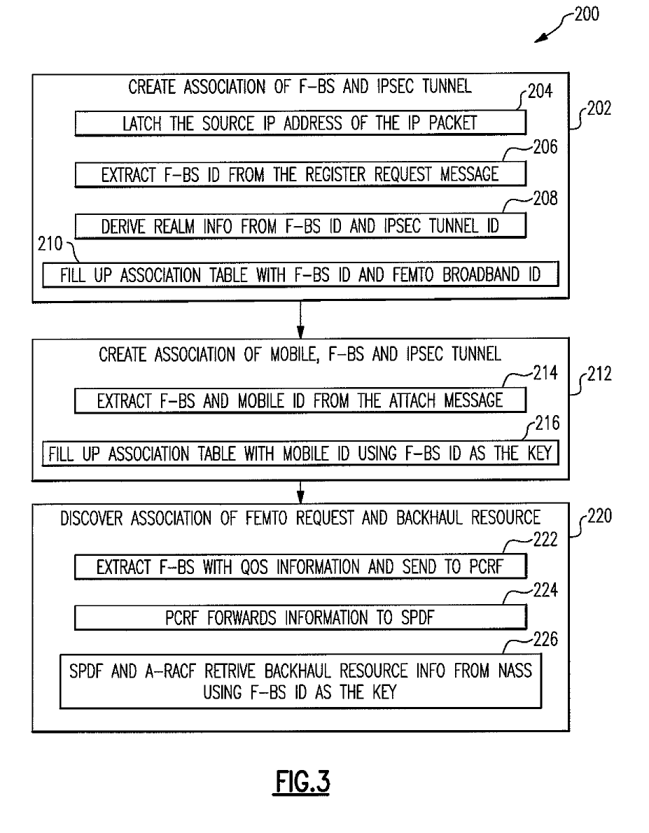

The procedures of establishing and discovering the association between the femto request and the wireline backhaul resource for one example are illustrated in FIG. 3. The flow chart diagram 200 includes a first step 202 at which the association of the F-BS and the IPSec tunnel is created. In one example, upon receiving the register request, the femto gateway 52 performs four actions. At 204, the femto gateway 52 latches the source IP address of the IP packet (i.e., external address) for the register request message. The femto gateway 52 extracts the F-BS ID from the same message as shown at 206. The femto gateway 52 also derives realm information based on the F-BS ID and the IPSec tunnel ID at 208. The association table is filled at 210 with the F-BS ID and the femto broadband ID.

At 212, the association of the mobile station 22, the F-BS and the IPSec tunnel is created. In this example, upon receiving the attach request, the femto gateway 52 extracts the mobile station and F-BS IDs from the attach message at 214. At 216, the femto gateway 52 uses the F-BS ID as the key to fill up the association table with the mobile station 22 ID.

The association of the femto request and the wireline backhaul resource is discovered at 220. Upon receiving the RAN session setup request, the femto gateway 52 extracts the F-BS ID with other quality of service information and sends that to the PCRF 58 at 222. The PCRF 58 forwards the information to the SPDF 66 at 224. The SPDF 66 and the A-RACF 68 retrieve the backhaul resource information from the NASS 76 (e.g., the IP address of the backhaul node and link resource) at 226 using the F-BS ID as the key.

Subscription authorization includes checking the subscription policy such as the maximum bandwidth allowed for Femto traffic based upon the quality of service class. The resource admission and reservation involves checking resource utilization over specific connections based on topology and circuit information from the NASS. The resource admission and reservation occurs based upon the wireline packet transport network policy in one example.

One example includes pushing down the policy decision to the relevant anchor elements such as the residential gateway 42, the anchor node 46, the edge node 50 or a combination of them for packet marking, policing and rate limiting operations.

Referring again to FIG. 2, the SPDF checks the service level agreement, white list, network policy or a combination of these to authorize the request and forwards the request to the A-RACF 68 for resource admission and reservation as schematically shown at 114. At 116 the A-RACF 68 queries the NASS 76 for subscriber profile and network topology or connectivity information using the F-BS ID (i.e., the globally unique IP address of the F-BS 24) as the key. At 118, the A-RACF 68 confirms the admission to the SPDF 66 at 118. Confirming the admission occurs after the A-RACF 68 checks the subscription and resource availability for admitting the request and reserving the necessary bandwidth.

In the illustrated example of FIG. 2, optional signaling is shown at 120 that involves the A-RACF 68 instructing at least one of the anchor points such as the residential gateway 42, the edge node 50 and the access node 46 for enforcing the policy decisions such as packet marking, policing and rate limiting.

At 122, the SPDF 66 provides a dynamic quality of service response for the backhaul resource by confirming the resource admission to the PCRF 58. At 124, the PCRF 58 confirms the quality of service response for the backhaul to the Femto gateway 52. At 126 the Femto gateway 52 performs the RAN/radio bearer setup. At 128 the Femto gateway responds to the SGSN 34 with the radio access bearer assignment such as providing the RAB ID information, TEID information, quality of service profile information and RNC IP address information. At this time, the GTP tunnel(s) establishment occurs on the Iu interface to dynamically provide the desired quality of service level over the wireline backhaul resource 44.

Optional signaling is shown at 130 in this example that allows for the SGSN 34 to notify the GGSN 32 if quality of service attributes are changed during the RAB assignment.

At 132 the transport bearer establishment is confirmed to the mobile station 22, which completes the end-to-end dynamic quality of service control procedure for that wireless communication session.

One aspect of this approach is that it allows for dynamically making a backhaul resource allocation to ensure quality of service for a F-BS 24 for a particular wireless communication session. Once that session is complete, those resources of the backhaul transport network are released and become available for a different wireless communication session involving the same devices or different devices, depending on the situation. Dynamically assigning backhaul resources to ensure quality of service avoids having to pre-configure and constantly dedicate particular backhaul resources to one or more F-BS's.

The above example is applicable to situations in which there are separate operators of the wireless network 30 and the wireline packet transport network 40 for the backhaul. The same example can be used when there is a single operator managing both networks. In a situation where there is a single operator responsible for the Femto wireless network and the wireline packet transport network for the backhaul, the implementation can be modified by concentrating more of the processing and decision making within the Femto gateway 52 and not having to rely as much on the PCRF 58. In other words, the example signal flow shown in FIG. 2 is not the only way of implementing dynamic quality of service control according to the principles of this invention.

The example dynamic quality of service control is applicable to various scenarios when a Femto bearer connection (i.e., IP-CAN session and bearers) is created or modified. The situations may involve establishing or modifying quality of service attributes. For example, a mobile station 22 previously in an idle mode initiates a service request procedure to send uplink signaling messages or data. Alternatively, core elements of the wireless core network 30 may initiate a service request procedure.

Another use for the dynamic quality of service control includes a handover where a mobile station moves from one routing area to another. Example routing area updates include intra-SGSN routing area updates or inter-SGSN routing area updates. Serving radio network controller relocations include intra-SGSN SRNS relocation or an intra-SGSN routing area update.

In most handover scenarios, the creation of a new IP-CAN session and bearer is initiated by the mobile station 22. A follow-on request may be generated by the mobile station 22 if there is pending uplink traffic. In other scenarios, a handover may be triggered by a relocation request sent from the new SGSN. Another use for the dynamic quality of service control includes modification of an existing application session or creation of a new application session. When preauthorized quality of service resources cannot accommodate the quality of service requirement for a new application session, for example, the mobile station 22 or the GGSN 32 initiates a request to create or modify IP-CAN session/bearers through transport signaling following normal procedures as defined in current 3GPP specifications, for example. In any one of these situations, the Femto gateway 52 initiates the dynamic quality of service control process upon receiving a RAN/radio bearer setup message from the SGSN 34.

One example method of dynamic resource admission control supported over the policy interface 64 includes aggregate resource reservation in which a certain amount of bandwidth in the backhaul is allocated to the Femto traffic upon an initial request such as during the IP-CAN establishment. The amount of bandwidth can be modified based on real usage and service level agreement parameters. The reserved resources are not considered available for regular broadband traffic through the residential gateway 42 except for best effort traffic in one example.

Another method of dynamic resource admission control is based on a per session resource reservation. The bandwidth and the backhaul in this example is dynamically allocated on demand for each application session. All unused resources are fully shared between Femto traffic and regular broadband traffic.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of facilitating communications involving a Femto base station (F-BS), comprising the steps of:
establishing an association between the F-BS, and a wireline backhaul resource used by the F-BS for initiating at least one traffic flow of the F-BS for a wireless communication session;
determining quality of service information for the wireless communication session;
determining a corresponding quality of service requirement of the wireline backhaul resource based on the determined quality of service information; and
using the established association for providing the corresponding quality of service to the F-BS on the wireline backhaul resource of the established association during the wireless communication session.

2. The method of claim 1, comprising releasing the wireline backhaul resource upon termination of the wireless communication session.

3. The method of claim 1, wherein establishing the association comprises receiving a registration request from the F-BS at a gateway;
associating an identifier of the F-BS with the wireline backhaul resource;
receiving a registration message regarding a mobile station provided by the F-BS to the gateway;
associating an identifier of the mobile station with the associated F-BS identifier and the wireline backhaul resource.

4. The method of claim 3, wherein the gateway comprises a Femto gateway that interfaces with an anchor point of a wireless communication network that facilitates the wireless communication session.

5. The method of claim 1, comprising
receiving a request for the corresponding wireline quality of service; and
granting the received request if at least one of a service level agreement or a network policy accommodate the received request.

6. The method of claim 5, comprising mapping quality of service parameters of the determined quality of service information for the wireless communication session to quality of service parameters useful for the wireline quality of service.

7. The method of claim 1, comprising using an Internet Protocol address of the F-BS to identify the wireline backhaul resource in the established association.

8. The method of claim 1, comprising
communicating between a wireless resource manager and a wireline resource manager for determining the corresponding quality of service requirement of the wireline backhaul resource.

9. The method of claim 8, comprising
checking a subscription profile of the F-BS or a mobile station registered with the F-BS for determining an allowable quality of service.

10. The method of claim 1, wherein the wireline backhaul resource is part of a packet transport network.
